(19) United States
(12) Patent Application Publication
(10) Pub. No.: US 2016/0145837 A1
(43) Pub. Date: May 26, 2016

(54) Wind Qanat, an Apparatus for Atmospheric Moisture Recovery

(71) Applicant: Seyed Farid ABRARI, Mississauga (CA)

(72) Inventor: Seyed Farid ABRARI, Mississauga (CA)

(21) Appl. No.: 14/551,028

(22) Filed: Nov. 23, 2014

(51) Int. Cl. E03B 3/28; F03D 9/00

(52) U.S. Cl. CPC E03B 3/28; F03D 9/00

(57) ABSTRACT

An apparatus and method for recovering atmospheric moisture is disclosed utilizing the blade system of a wind turbine to both drive the compressor of a rotary refrigeration system and to provide a rotary turbo-machinery surface for its evaporator; whereon atmospheric moisture is recovered by reducing the temperature and pressure of the driving humid air. The rotational speed of the wind turbine is then used to maximize the rate of condensation; which is continuously centrifuged out from the rotary frame of blades into a stationary circular gutter where they accumulate and discharge. In the practice of this invention, a compressor with a rotary intake & discharge port is directly connected to a rotary evaporator & rotary condenser, generating a rotary refrigeration system wherein pressure of the liquid refrigerant is enhanced by the centrifugal force of rotation, enhancing the refrigeration capacity and condensation output.

### FIELD OF INVENTION

This invention relates generally to the wind turbines and, more particularly to those with cooled blades designed to extract liquid water from a humid air stream.

### BACKGROUND AND DESCRIPTION OF PRIOR ART

Due to the adverse effects of global climate change and those of rapid development and population growth at some regions of the planet, the urgency and demand for a dependable source of fresh water is alarmingly on the rise. One of the inexhaustible sources of water is in the form of vapour in the atmosphere, particularly, in regions with relatively warm and humid climates. Recognising this, several devices have been previously described for generating liquid water from moisture in the atmosphere. One class of said devices rely on the well established and widely used vapour compression refrigeration cycle with proven technologies and mechanical and thermodynamic design methods. In these devices, a refrigerant is circulated through a closed circuit cycle of condensation and evaporation to produce the cooling effect needed for condensation of water vapour on a surface. Cooling is accomplished by the heat absorption of the liquid refrigerant while evaporating at a low pressure within a closed volume called evaporator.

Swanson, in U.S. Pat. No. 3,675,442 discloses an atmospheric water collector which employs a cooling coil immersed in a fresh water bath which cools the bath using mechanical refrigeration device. The cooled water is pumped through a conduit and condensing frame. A housing is provided to channel flow of moisture laden air at ambient temperature over condensing frame where condensed water drains into a collector. If the condensed water is below a predetermined temperature it is mixed with the fresh water bath. An external power source is needed to drive both the refrigeration device and the water pump.

Nasser et al, in U.S. Pat. No. 4,182,132 discloses a device requiring a pair of vertically aligned spaced apart air chambers for operation, and suggests mounting the device on a post or a vertically extending support. Two fans operate in tandem. The humid air drawn into the system is partly forced through an air guide channel upwardly through the condenser of the refrigeration system (where it warms up and rise) and partly is forced downwardly through the evaporator of the refrigeration system (where it cools down and sink) to condense. While the arrangement allows for large volume of humid to traverse the cooling surface, however, an external power source is required for refrigeration and operation of the fans.

Engel et al, in U.S. Pat. No. 5,259,203 disclose an apparatus and method for extracting potable drinking water from moisture-laden atmospheric air through the use of a refrigeration system where a compact housing also contains a reservoir which may contain a secondary evaporator unit and condenser unit. A fan pulls a stream of atmospheric air through a filter and through the evaporator to clean and cool the air and exhausts cooled air through the condenser. The water is collected as condensation by the evaporator and directed to the reservoir through a filter system and a water seal. The secondary evaporator is submersed in the cool water compartment for cooling the water collected in the reservoir and the secondary condenser is submersed in the warm water compartment for heating the collected water. Here again operation of the system require an external power source.

Smith, in U.S. Pat. No. 4,433,552 discloses an apparatus and method for recovering atmospheric moisture utilizing a wind driven electrical generator for powering a mechanical refrigeration system for condensing atmospheric moisture. The refrigeration system includes an evaporator positioned in the atmospheric duct whereon water vapor is condensed. In the practice of the method for recovering atmospheric moisture, electrical current is generated from wind and powers the refrigeration system which includes the evaporator. Atmospheric moisture is condensed on the evaporator and collected.

Dagan, in U.S. Pat. No 6,644,060 discloses an apparatus for extracting potable water from the environment air comprising a moisture collecting system having dew-forming surfaces and disposed so that the air drawn into the apparatus passes there through and moisture from the air condenses in the dew-forming surfaces. The apparatus described therein is powered by an electrical source.

In the devices mentioned above, the temperature of humid air needs to be sufficiently lowered to allow for condensation of water vapour therein. To achieve this, the refrigeration system, in turn, needs an electrical source of power to drive the mechanical components in the mentioned systems, such as a compressor, pump, fan, etc. Goelet, in U.S. Pat. No 8,747,530 describes these prior art technologies as complex, energy consuming, non-portable and expensive. Therefore, he discloses an apparatus that does not use a refrigeration process for condensation of water vapor. His system, instead, includes a “housing” having a plurality of openings allowing an air flow to enter into an inner space defined by the housing. The system also includes a “sponge” disposed within the inner space defined by the housing. The sponge includes a water absorbing/adsorbing material for absorbing/adsorbing water vapor from the air flow. The system further includes a “presser” disposed above the sponge and configured to compress the sponge to discharge water from it. The disclosure is then directed to a system which includes a plurality of rotatable blades, such as a fan or wind turbine, with the water absorbing/adsorbing material applied to its surfaces. While the function of “housing” in the original embodiment is accommodated by a “shell structure” fully surrounding the blades, no further detail is given on how the functions of sponge and presser are accommodated in this particular embodiment.

### SUMMARY OF THE INVENTION

In the practice of the present invention, an apparatus is provided, herein called Wind Qanat (WQ), comprising a wind turbine with a plurality of cooled blades drivingly connected to a main shaft of a rotary compressor, which is also drivingly connected to a rotary condenser. In addition to transferring wind power, the key feature of the main driving shaft is that it houses a plurality of low and high pressure gas lines within, as a means of delivering a low pressure (LP) superheat to the rotary compressor and returning a pressurized (HP) gas to the rotary condenser. The HP refrigerant, now in the liquid phase, exits the rotary condenser and under the influence of centrifugal force of rotation travels through a recuperating heat exchanger, which is aligned generally radially-outwardly along the blade trailing edge (TE), and while loosing heat to a cooled air leaving the blade system gains centrifugal pressure before entering into the blade rotary evaporator, which is aligned generally radially-inwardly along the blade span, wherein it vaporizes to cool the suction and pressure surfaces of the blade, before returning, through the main driving shaft, to the suction port of the compressor to complete a full rotary refrigeration cycle within the apparatus. The casing wall of the compressor, mounted on a vertically extended support structure, is the only stationary component of the rotary refrigeration system described above, hence, the compressor rotors, the refrigerant itself, the condenser, the recuperating heat exchanger, the evaporator and the connecting HP and LP lines are all rotating with the rotation of wind turbine blades. Evidently, by passing through the WQ, a humid air drives the compressor of the rotary refrigeration system while condensing on the cooled surfaces of the turbine blades. A barrage of small openings, located on the trajectories of the rotating condensations, then collect and continuously centrifuge the water droplets out into an opening of a circular gutter, where they flow and cumulate at the bottom dead center (BDC), where a control system measures and maximizes the flow rate by controlling the turbine speed (RPM) for the instantaneous atmospheric condition of the wind speed, absolute humidity and the ambient temperature.

According to this invention, a Wind Qanat has three key features that maximizes liquid water production under similar atmospheric condition compared to the prior art. First is due to the enhancement that a refrigeration cycle may attain when operating in a rotating frame. Fundamentally, fluid density being higher in the liquid phase than the gaseous, a higher centrifugal pressure is exerted on the former than the latter, and hence, compared to a stationary system with the same refrigeration capacity, a reduced power is needed to drive the compressor of a rotating refrigeration system. Second, a predominantly negative pressure of the suction side of a turbine blade tends to locally increase relative humidity of the passing air, and hence promote the condensation process when exposed to cooled suction surfaces. Finally, a recuperator stretching along the blade TE, where a cooled dried air is exiting the system, tends to cool the liquid refrigerant before entering into the rotary evaporator, and hence, further reduce the thermodynamic losses in the WQ system.

Therefore, the principal objects and advantages of the present invention are: 1) to provide an apparatus for extracting liquid water from a humid wind flow; 2) to provide such an apparatus which uses a rotary refrigeration cycle within a turbo-machinery system to generate cooled surfaces whereon water vapour is condensed; 3) to provide such an apparatus which uses the rotary frame of a wind turbine blade to generate a rotary refrigeration cycle within; 4) to provide such an apparatus which uses a compressor with a rotary discharge and intake ports; 5) to provide such an apparatus which uses a drive shaft as a means to drive the compressor and also to communicate the refrigerant fluid through; 6) to provide such an apparatus which uses a rotary condenser to cool and condense the HP refrigerant; 7) to provide such an apparatus which uses the gravitational field of rotation to further increase liquid refrigerant pressure, and hence, reduce the power requirements of the compressor; 8) Hence, to provide such an apparatus which is more efficient compared to the prior art; 9) to provide such an apparatus which uses the negative pressure on blade suction side to increase relative humidity of the passing air locally, and hence, promote condensation of water vapour thereon; 10) Hence, to provide such an apparatus which is more efficient compared to the prior art; 11) to provide such an apparatus which uses a cooled dried air exiting the system to cool the HP liquid refrigerant, and hence,, reduce thermodynamic losses; 12) Hence, to provide such an apparatus which is more efficient compared to the prior art; 13) to provide such an apparatus which uses wind power to drive the process directly, hence, eliminate the need for an electric source of power for the refrigeration cycle; 14) Hence, to provide such an apparatus which is more efficient compared to the prior art; 15) to provide such an apparatus which uses blade-to-air relative velocity as a means to influence heat transfer therebetween; 16) to provide such an apparatus which uses turbine RPM to influence said relative velocity; 17) to provide such an apparatus which uses the compressor power consumption as a means to control turbine RPM; 18) to provide such an apparatus which operates on its peak efficiency by controlling the wind turbine RPM for the prevailing combination of the wind speed, air temperature and absolute humidity; 19) to provide such an apparatus which uses a barrage of small openings on the blade surfaces to lead the condensation out of the rotating blades; 20) to provide such an apparatus which uses hydrophobic and hydrophilic coatings to enhance collection and discharge of the condensation from the rotating blades; 21) to provide such an apparatus which uses a curved gutter with a varying spiral-like cross-section to collect the condensation into a stationary outlet.

The objects and advantages of this invention, as describe above, will become more apparent from the following detailed descriptions taken in conjunction with the accompanying drawings wherein are set forth, by way of illustration and example, certain embodiments of this invention.

### BRIEF DESCRIPTION OF THE DRAWINGS

FIG. 1 is a side view of an apparatus for recovering atmospheric moisture embodying the present invention;

FIG. 2 is a front view of the interior of a cooled wind turbine blade, illustrating the fluid lines and evaporation chambers, as well as a recuperator mounted on the trailing edge, outside of the blade;

FIG. 3 is a side cross-sectional view of the blade at TE, illustrating the recuperator, a heat transfer fin and its connection to the blade, as well as the condensation openings on the pressure and suction sides of the blade;

FIG. 4A is a top (horizontal) cross-sectional view of an embodiment of a rotary screw compressor illustrating the drive shaft and the rotary intake and discharge ports;

FIG. 4B is a side (vertical) cross-sectional view, through section A-A of FIG. 4A, illustrating the mechanical and fluid connection of the drive shaft to the rotary compressor and its LP and HP sides within;

FIG. 4C is a front cross-section view of the drive shaft at sections B-B, C-C and D-D of FIG. 4B, illustrating an embodiment of the LP & HP lines at three functionally distinct locations;

FIG. 5A is a schematic side view of a rotary condenser showing a fluid line branching out from the end of HP line exiting the rotary compressor. Each cooled turbine blade generally may have a dedicated line; however, only one line is shown here for clarity;

FIG. 5B is a schematic front view of the rotary condenser of FIG. 5A, showing a fluid line branching out from the end of HP line. Each cooled turbine blade generally may have a dedicated line; however, only one line is shown here for clarity;

FIG. 6 is a front view of the exterior of the blade of FIG. 2, illustrating a barrage of small openings on its surface used for collection of the condensation, and an interior network of small open tubes used for discharge of the condensation;

FIG. 7 is a simplified front of view of the apparatus, showing position of the gutter relative to the blade tips;

FIG. 8A is a side cross-section view of an embodiment of a gutter with a circular outline and a spiral-line cross-section;

FIG. 8B is an illustration of the gutter spiral-like cross-section at TDC and BDC, as well as its variation versus height

FIG. 9 is a notional illustration of the peak efficiency running line, sought by the controller, under a constant wind speed and air temperature, but varying absolute humidity;

FIG. 10A is another embodiment of a rotary compressor with rotary intake and discharge ports;

FIG. 10B is yet another embodiment of a rotary compressor with rotary intake and discharge ports;

These drawings constitute a part of this specification and include exemplary embodiments of the present invention and illustrate various objects and features thereof;

### DESCRIPTION OF THE PREFERRED EMBODIMENTS

Detailed embodiments of the present invention are described herein, however, it is to be understood that the disclosed embodiments are merely exemplary of the invention which may be embodied in many various other forms. Therefore, specific structural and functional details disclosed herein are not to be interpreted as limiting, but merely as a basis for the claims and as a representative basis for teaching one skilled in the art to variously employ the present invention in virtually any appropriately detailed structure.

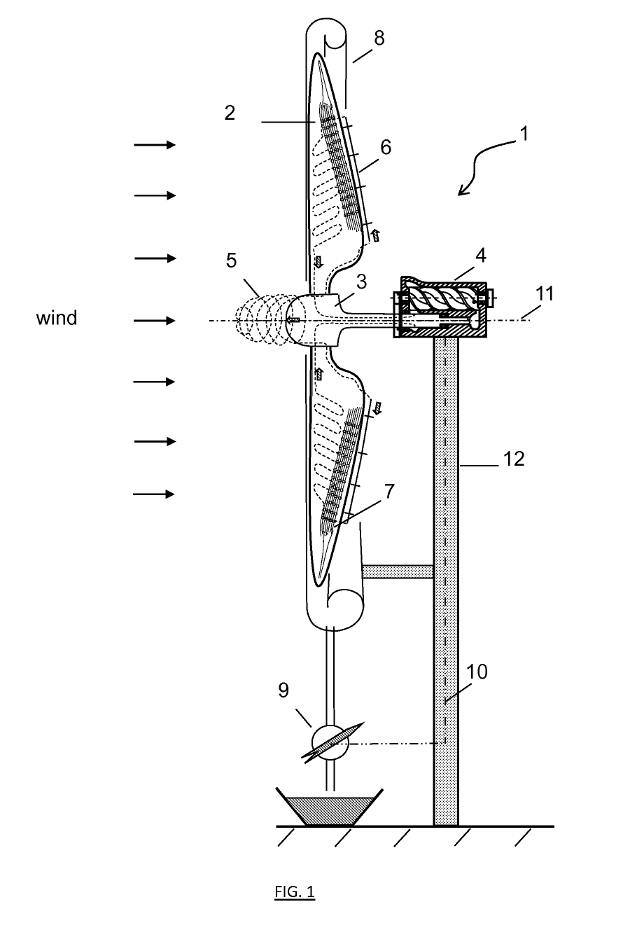

Now referring to the drawings in more detail, the reference numeral 1 of FIG. 1 generally illustrates an apparatus for recovering atmospheric moisture comprising of at least one internally cooled wind turbine blade 2, drivingly connected to a main power shaft 3, to drive a rotary compressor 4 and an integrally connected rotary condenser 5. The system also includes at least one rotary recuperator 6, a condensation collection network 7, a stationary curved gutter 8 and a control system with flow metering device 9 capable of maximizing liquid water production by controlling the compressor exit pressure. In FIG. 1, also shown is the general direction of refrigerant flow in a rotary system, wherein the radially outward flow must always be the liquid refrigerant and radially inward flow the superheat gas.

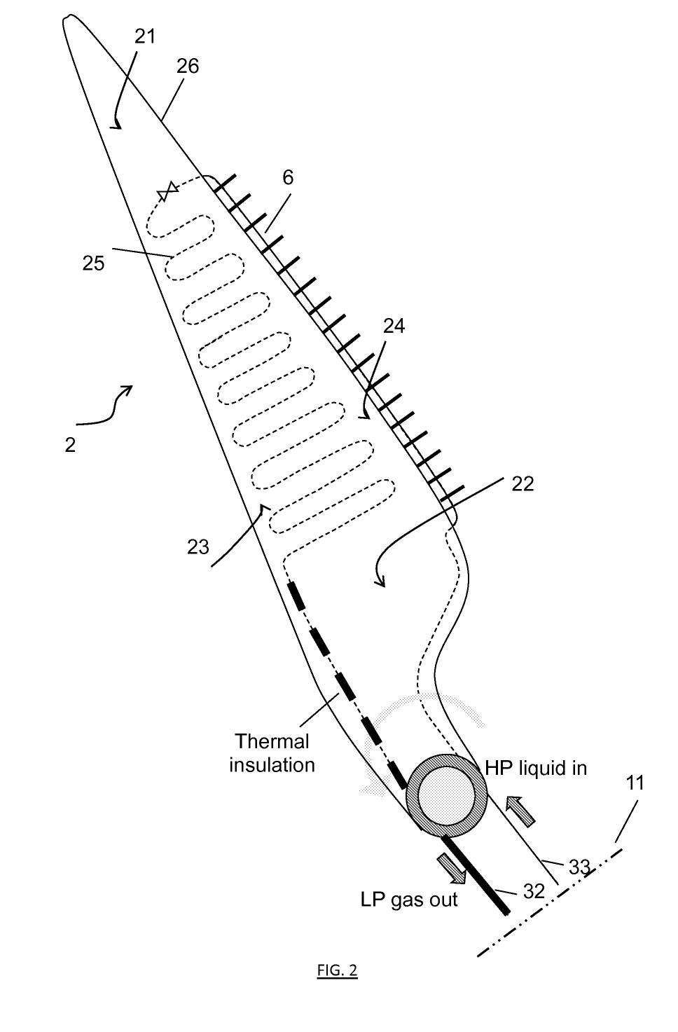

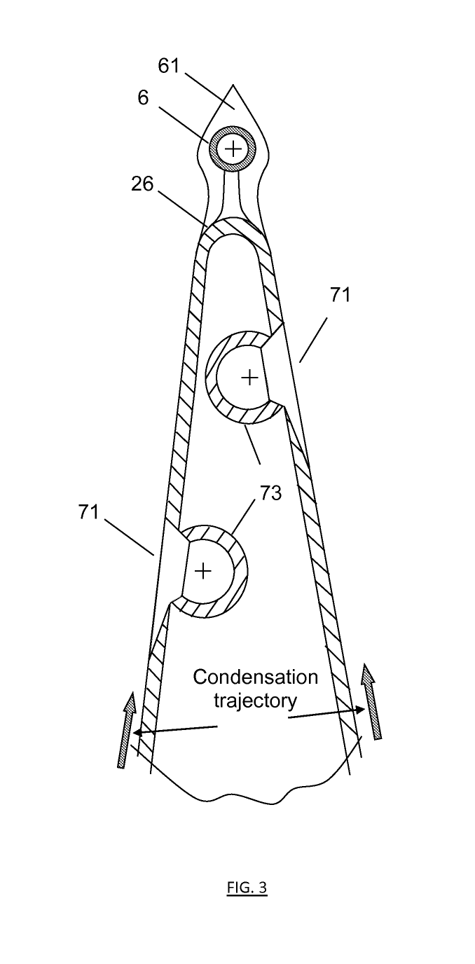

As shown in FIG. 2, the turbine blades 2 have an axis of rotation 11, and a tip area 21 defined as being at a higher radius than a root area 22, and a leading edge (LE) area 23 defined as being at upstream of a TE area 24. The turbine blade 2, includes at least one internal evaporation chamber 25, generally aligned in a direction normal to 11, covering a blade section stretching from a tip area to a root area in the span direction, and from a LE area to a TE area in the chord direction; wherein a liquid refrigerant evaporates, and while traveling in a radially inwardly direction, cools the affected surfaces on both suction and pressure sides of the blade that are thermally connected to the evaporation chamber 25. The turbine blade 2, also includes at least one recuperator 6, structurally attached within a distance from the TE, stretching from a similar root to tip area that the internal evaporator 25 is located within the blade. Therefore, before fully exiting the blade system, the air stream, which is now colder and drier upon contact with the blade surfaces, exchanges heat with the liquid refrigerant flowing radially outwardly inside the recuperator 6 to cool it further before entering into the evaporation chamber 25. As shown in more details in FIG. 3, the recuperator 6 has a plurality of thin aerodynamically designed fins 61 to enhance the heat exchange and also to structurally connect the recuperator 6 to the blade 2 at TE 26. The said fins may have noise attenuating geometrical features. A thermally insulated LP line 32 in each blade, then returns the superheat exiting the rotary evaporation chamber 25 to its corresponding thermally insulated LP line 32 within the main driving shaft 3.

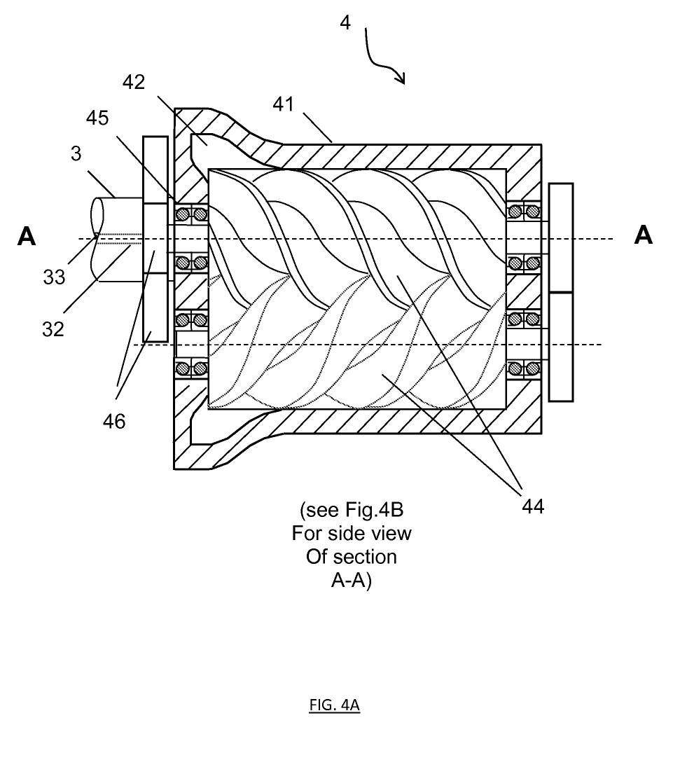

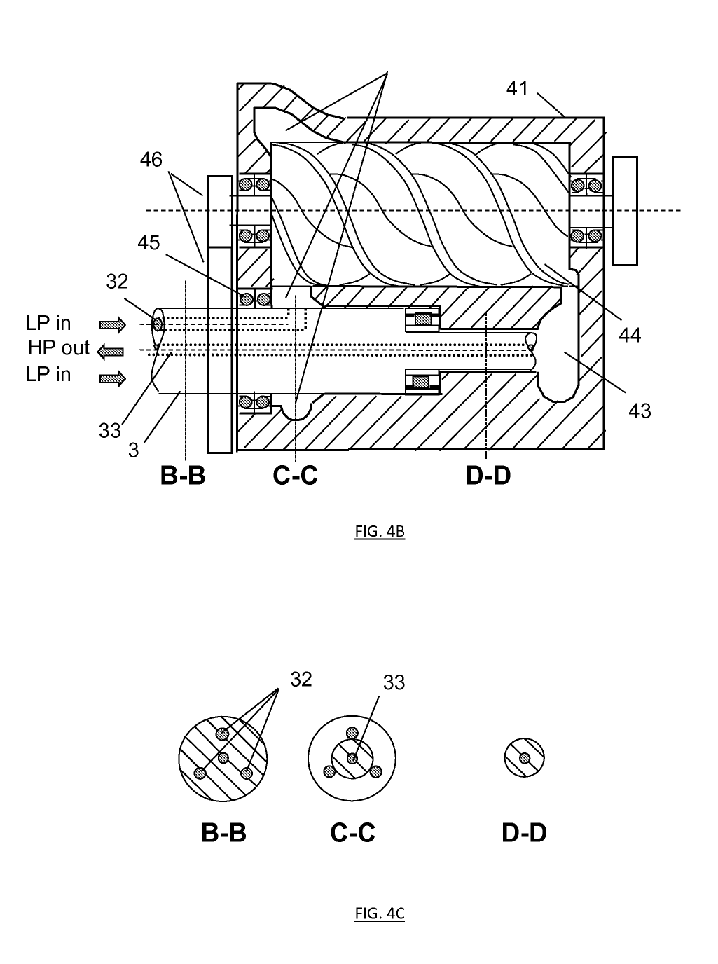

Now referring to FIG. 4A, a top view of an exemplary embodiment of a rotary screw compressor 4 is given, which unlike prior art, has its rotary intake and discharge ports through the main driving shaft 3. Hence, in this particular embodiment, there is no stationary intake or discharge port on the casing wall 41 of the said compressor. In FIG. 4B, a side view through section A-A of FIG. 4A, reveals the internal structure of the compressor 4 and its spiral rotors 44 in relation to the main driving shaft 3, which is extended into the compressor interior through a bearing support 45 and a gear train 46. In FIG. 4C, the front views through sections B-B, C-C and D-D of FIG. 4B, reveal the internal structure of the main driving shaft 3, at these three functionally distinct sections, wherein the insulated peripheral LP lines 32 are connected to the LP side 42 of the spiral rotors 44, and the central HP line 33 of the said shaft is connected through a roller bearing to the HP side 43 of the said spiral rotors. It is now clear that in this invention the main driving shaft communicates the mechanical torque to and the working refrigerant in and out of the rotary compressor.

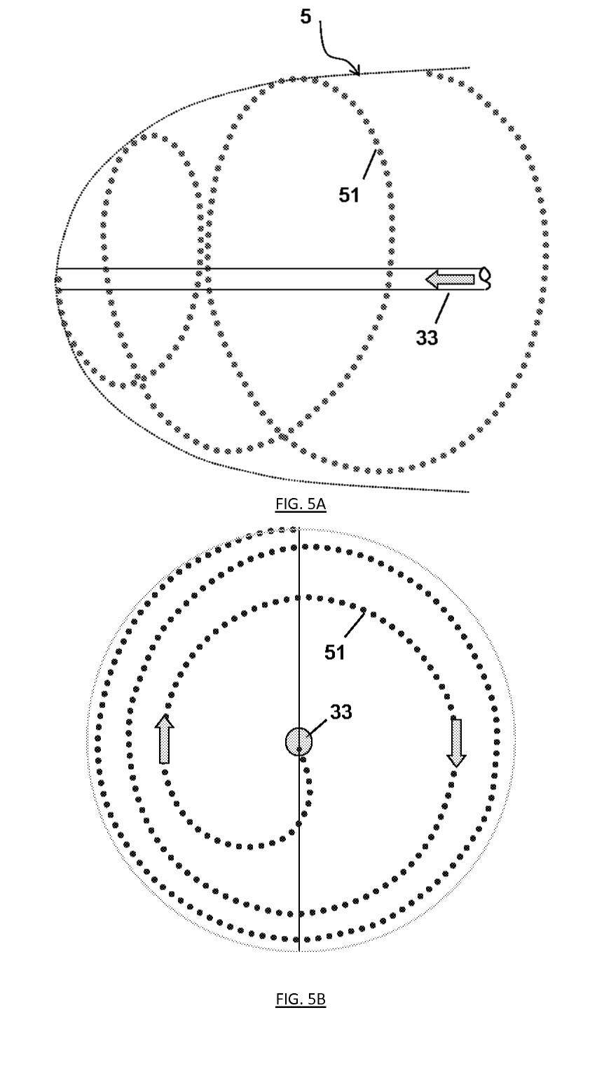

The refrigerant exiting the compressor, now pressurized and hot, is then delivered through the HP line 33 of shaft 3 to the rotary condenser 5, mounted at the other end of the said shaft, facing the incoming wind. As shown in FIG. 5A, at the end of line 33 the HP gas is then divided into a plurality of outwardly winding coils 51 (for clarity only one is shown in the FIG.) with enough length and surface area to allow the HP refrigerant to condense therein by means of heat exchange with the ambient air. To further promote HP condensation within the coil system, a plurality of aerodynamically shaped fins may be attached to the coils to structurally support the windings against the force of rotation while accelerating air through the condenser. FIG. 5B, a front view of the rotary condenser, reveals that the direction of coil winding must be in the direction of rotation of the turbine.

The refrigerant, now in liquid state, exits the rotary condenser 5, and by travelling in a radially-outwardly path, through the blade root and the recuperator 6, returns to the rotary evaporator 25 to complete one rotary refrigeration cycle in the Wind Qanat system.

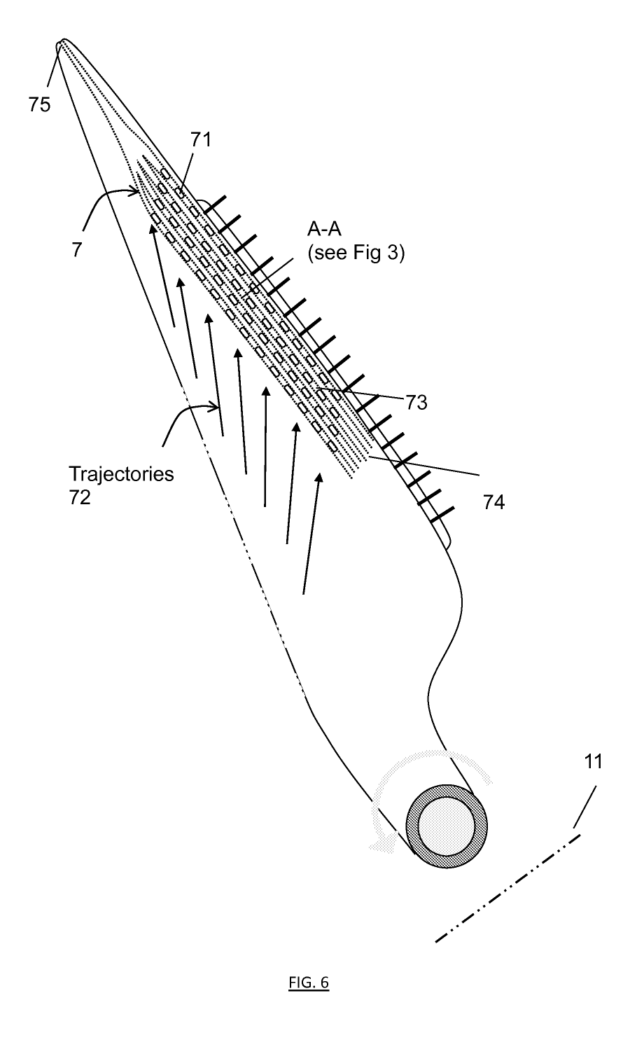

Having the liquid water droplets now condensed on the cooled sections of the rotating blades, we turn our attention to means of collecting and discharging them from the rotating frame. FIGS. 6 and 3, shows an exemplary embodiment of a barrage of small openings 71, made on the exterior surfaces of the blades near the trailing edge area 24 downstream of the evaporator, where they collectively block LE 26 from direct line of sight of the cooled surfaces. Hence, in any operating turbine RPM, trajectories of the condensation droplets, notionally shown by 72, take them to at least one such an opening, where they enter into a plurality of small and generally radially oriented tubes 73, which have their both ends 74 and 75 open. Droplets in the tubes 73, then accelerate under the influence of centrifugal forces and collectively exit from an opening 75 located at the very tip of the blade. Blade surfaces on cooled sections may have a hydrophilic coating to promote condensation traction, whereas the discharge tubes 73 may have a hydrophobic coating to promote radial acceleration of the droplets.

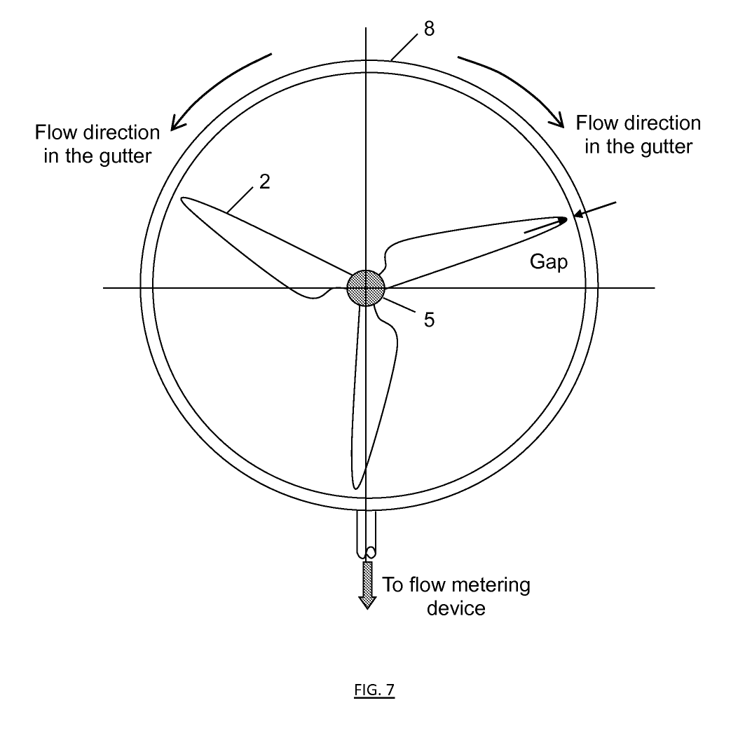

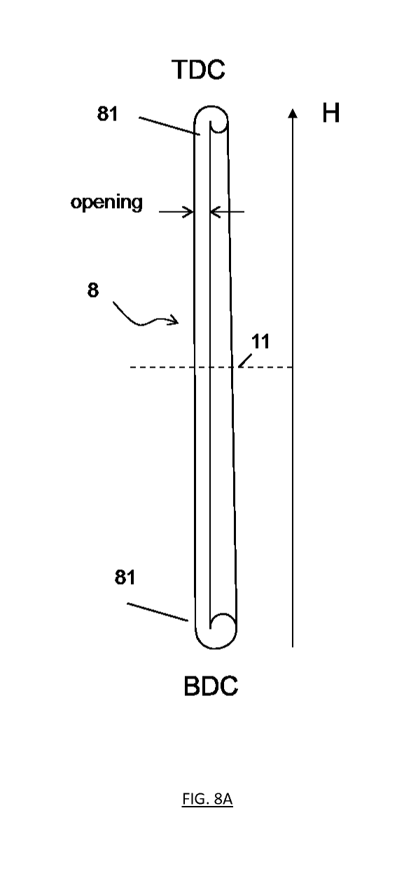

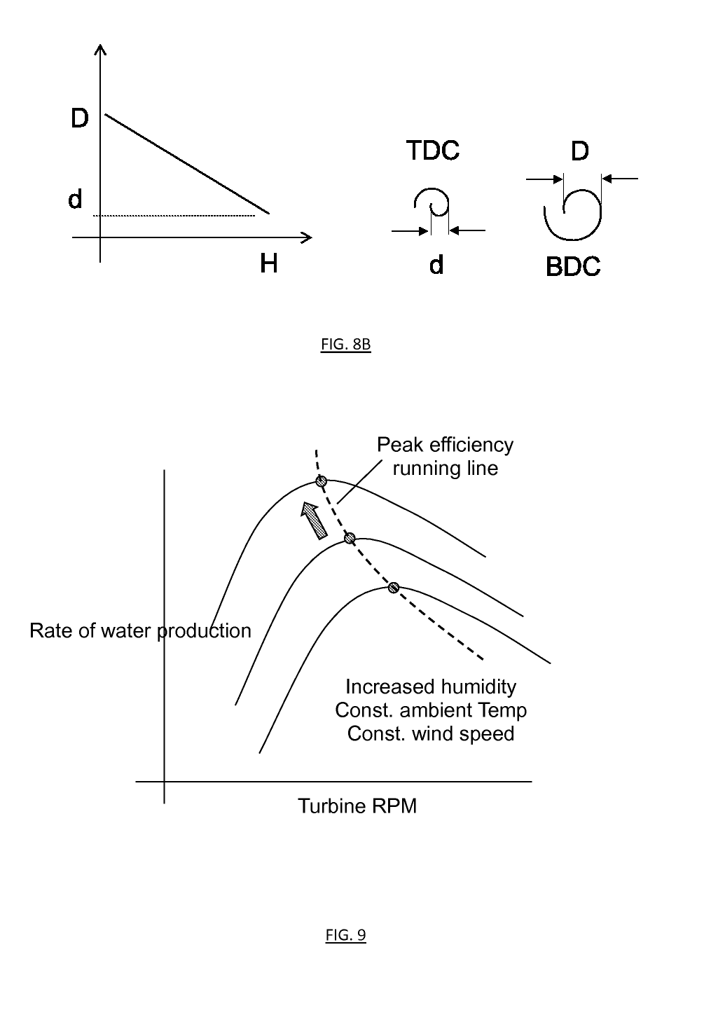

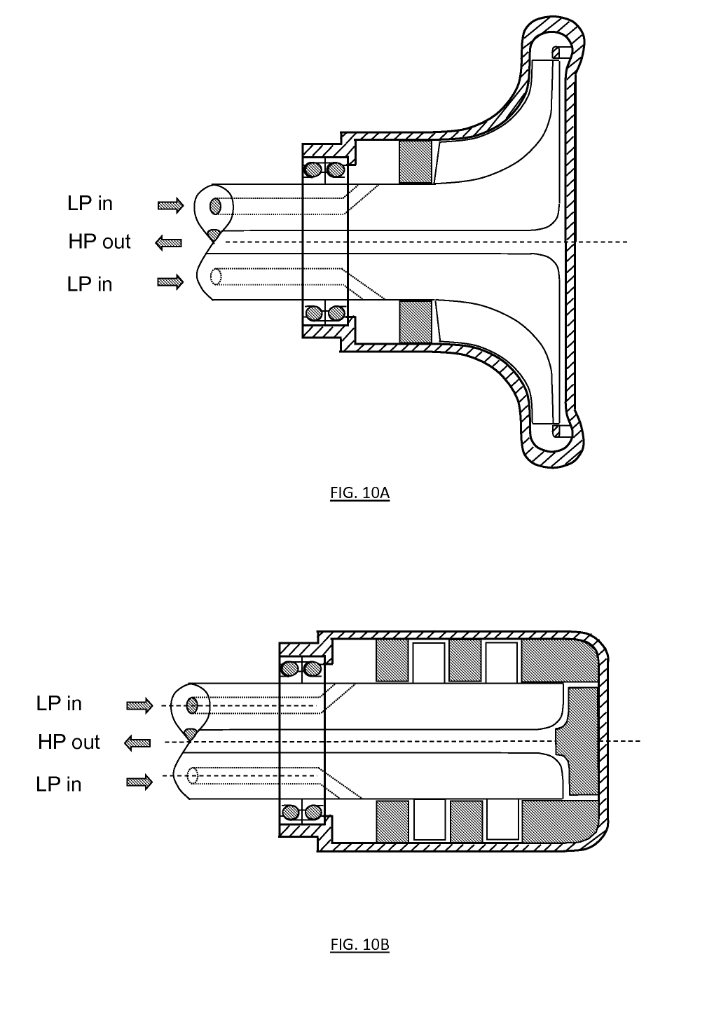

Now turning back to reference FIG. 1, a stationary curved gutter 8 with a spiral-like cross-section is shown, which wraps around the circular path of the blade tip, with an opening 81 aligned with the condensation outlet 75. FIG. 7, a simplified front view of the apparatus, reveals that a safe gap exits between the gutter and the blade tip. The condensation droplets, which now under the influence of centrifugal forces have accelerated to a sufficiently high speed, exit the outlet 75, freely travel the said gap and enter into the gutter 8, through the opening 81, wherein the spiral-like cross-section absorbs the kinetic energy of the droplets and channels them, from both the left and right half-sides, to the BDC of the gutter. As revealed in FIG. 8, the gutter may have a varying channel diameter along its height with a maximum diameter D located at the BDC and a minimum diameter d at TDC, which may be a favourable feature in its construction.

The system condensation output, which is now in the form of a continuous flow of liquid water at the BDC of the gutter, passes through a flow metering device 9, wherein a control system measures the volumetric rate of liquid water output. Depending on the prevailing combination of the wind speed, absolute humidity and the ambient temperature at the time of said measurement, the controller adjusts the turbine RPM to maintain the system at its peak efficiency running line, as notionally illustrated in FIG. 9 for a constant wind speed and ambient temperature parameters, but varying absolute humidity—as an example. In a particular embodiment shown in FIG. 1, the turbine RPM is controlled, indirectly, by a command signal 10 sent to a load valve in the casing wall of the rotary compressor to adjust the HP exit pressure, equivalently, the compressor power consumption.

The above description is meant to be exemplary only, and one skilled in the art will recognize that alterations may be made to the embodiments described without departing from the scope of the invention disclosed. For instance, one can include a gearbox in the apparatus to drive the compressor in one mode of operation, and an electric generator in another, such that in the latter mode apparatus reduces to a normal wind turbine for electric power generation. Still other modifications which fall within the scope of present invention will be apparent to those skilled in the art, in light of a review of this disclosure, and such modifications and applications are intended to fall within the scope of the appended claims.

What is claimed:

1. An apparatus for recovering atmospheric moisture, the apparatus comprising:
(a) a gutter to receive, accumulate and discharge recovered liquid water;
(b) a wind turbine inside said gutter within a clearance gap from it;
(c) a refrigeration system to cool exterior surfaces of said turbine blades;
(d) a collection means to centrifuge out condensation droplets into said gutter;

2. A compressor with rotary discharge and intake ports, comprising:
(a) a rotary driving shaft, which also integrally houses at least one line for delivery of low pressure (LP) gas to the compressor and one line for return of pressurized (HP) gas from it, such that;
(b) said LP and HP lines are thermally insulated from each other, and;
(c) said LP line leads to the intake side of the compressor, and;
(d) said HP line leads to the discharge side of the compressor;

3. An apparatus for cooling a fluid or gaseous medium, while propelling or extracting energy from it, comprising:
(a) a rotary turbo-machinery blade to house a refrigeration evaporator within, such that;
(b) said evaporator having thermally connected to the exterior surfaces of said blade, and;
(c) said evaporator having its inlet located at a higher rotational diameter compared to its outlet, such that;
(d) blade gravitational field of rotation to centrifuge denser liquid refrigerant radially-outwardly towards said evaporator inlet, and also;
(e) push lighter gaseous superheat to flow radially-inwardly within the evaporator towards said outlet;

4. The apparatus as defined in claim 3, wherein the compressor of the rotary cooling system is as defined in claim 2;

5. The apparatus as defined in claim 4, wherein condenser of the cooling system is also rotary;
i.e., it is rotating with the turbo-machinery system;

6. The apparatus as defined in claim 5, wherein;
(a) coils of said rotary condenser wind in the same direction of rotation of the turbo-machinery system;
(b) a plurality of aerodynamically shaped heat transfer fins accelerates the ambient air through the condenser while structurally supports the coils against the force of rotation;

7. The apparatus as defined in claim 1, wherein said gutter has an outlet at its BDC vicinity;

8. The apparatus as defined in claim 7, wherein said gutter has a spiral-like folded section to absorb and contain kinetic energy of the accelerating droplets as they exit blade rotating frame of reference;

9. The apparatus as defined in claim 8, wherein said gutter has a reducing sectional flow capacity v.s height;

10. The apparatus as defined in claim 1, wherein blade cooling system is defined as in claim 6;

11. The apparatus as defined in claim 10, wherein a recuperating heat exchanger is mounted downstream of the blade TE, to recover otherwise wasted refrigeration capacity of the cooled air exiting the system;

12. The apparatus as defined in claim 1, wherein a barrage of small openings collectively block line of sight of blade TE from any point on the cooled sections, such that trajectories of all condensation droplets on said sections intersect with at least one such opening;

13. The apparatus as defined in claim 12, wherein said openings lead to a plurality of small and generally radially-oriented tubes, having their both ends open, to allow discharge of the condensation droplets out into the opening of the gutter;

14. The apparatus as defined in claim 13, wherein a hydrophobic coating is applied onto said tubes to promote centrifugal acceleration of the condensation droplets;

15. The apparatus as defined in claim 1, wherein a hydrophilic coating is applied onto the blade cooled sections to promote condensation traction and stable trajectories of the droplets;

16. The apparatus as defined in claim 1, wherein the flow rate of the liquid water at the outlet of the gutter is measured and maximized by a control system;

17. The apparatus as defined in claim 16, wherein said control system uses the turbine RPM as the controlling parameter to keep the apparatus operating on its peak efficiency running line, corresponding to the peak rate of water production, as the atmospheric conditions relating to the wind speed, humidity or air temperature change;

18. The apparatus as defined in claim 10, wherein the exit pressure of the rotary compressor is used to influence the turbine RPM, hence, the rate of water production;

19. The apparatus as defined in claim 18, wherein said turbine is drivingly connected to a gearbox with at least two distinct modes of operations:
(a) 1^{st} mode to drive a blade cooling system;
(b) 2^{nd} mode to drive an electric power generator;

20. The apparatus as defined in claim 19, wherein said control system automatically switches to the 2^{nd} mode of operation when the rate of water production is below a pre-set value, due to a poor humidity condition, for example, hence reducing the apparatus to a normal wind turbine electric power generator.
